(19) United States
(12) Patent Application Publication
(10) Pub. No.: US 2008/0207443 A1
(43) Pub. Date: Aug. 28, 2008

(54) Sorbent comprising activated carbon, process for making same and use thereof

(76) Inventors: Kishor Purushottam Gadkaree, Big Flats, NY (US); Benedict Y. Johnson, Horseheads, NY (US); Youchun Shi, Horseheads, NY (US)

Correspondence Address: CORNING INCORPORATED, SP-TI-3-1, CORNING, NY, 14831, US

(21) Appl. No.: 11/803,368

(22) Filed: May 14, 2007

Related U.S. Application Data
(60) Provisional application No. 60/904,113, filed on Feb. 28, 2007.

(51) Int. Cl. C01B 31/08

(52) U.S. Cl. 502/417; 502/416

(57) ABSTRACT

A sorbent body adapted for abating toxic elements from a fluid stream, such as a carbon combustion flue gas stream or a syngas stream produced in coal gasification process, and process for making such sorbent. The sorbent body comprises an activated carbon matrix defining a plurality of pores, sulfur and additive adapated for promoting the abatement of toxic elements from the fluid stream. The sorbent is useful for abatement of, e.g., arsenic, cadmium, mercury and selenium from gas streams.

### CROSS-REFERENCE TO RELATED APPLICATION

The present application claims the benefit under 35 U.S.C. § 119 of the earlier filing date of U.S. Provisional Patent Application Ser. No. 60/904,113, filed on Feb. 28, 2007, and entitled “MERCURY ABATEMENT DEVICE AND FABRICATION THEREOF,” the content of which is incorporated herein by reference in its entirety.

### GOVERNMENT INTEREST INFORMATION

This invention was made with Government support under Agreement No. DE-PS26-04NT42249-4B awarded by University of North Dakota—Energy and Environmental Research Center by the Department of Energy-NETL. The Government has certain rights in this invention.

### FIELD OF THE INVENTION

The present invention relates to sorbent bodies comprising activated carbon. In particular, the present invention relates to sorbent bodies comprising activated carbon and sulfur, and capable of removing toxic elements from a fluid stream such as a gas stream, process for making such sorbent bodies and use of such sorbent bodies in abating such toxic elements. The present invention is useful, for example, in abating mercury from the flue gas stream resulting from carbon combustion.

### BACKGROUND OF THE INVENTION

Mercury is both a global pollutant and a contaminant that can be transformed to a potentially toxic species (e.g., methylmercury) under natural conditions. Mercury emitted to the atmosphere can travel thousands of miles before being deposited to the earth. Studies show that mercury from the atmosphere can also be deposited in areas near the emission source. Mercury intake by human beings, especially children, can cause a variety of health problems.

Coal-fired power plants and medical and municipal waste incineration are major sources of human activity relating to mercury emission to the atmosphere. It is estimated that there are 48 tons of mercury emitted from coal-fired power plants in US annually. However, so far there is no effective mercury emission control technology available at a reasonable cost, especially for elemental mercury emission control.

The state of the art technology that has shown promise for controlling elemental mercury as well as oxidized mercury is active carbon injection (ACI). The ACI process includes injecting active carbon powder into the flue gas stream and using fabric fiber (FF) or electrostatic precipitator (ESP) to collect the active carbon powder that has adsorbed mercury. Generally, ACI technologies require a high carbon to Hg ratio to achieve the desired mercury removal level (>90%), which results in a high cost for sorbent material. The high carbon to Hg ratio suggests that ACI does not utilize the mercury sorption capacity of carbon powder efficiently. A major problem associated with ACI technology is cost. If only one particle collection system is used, the commercial value of fly ash is sacrificed due to its mixing with contaminated activated carbon powder. A system with two separate powder collectors and injecting activated carbon sorbent between the first collector for fly ash and the second collector, or a baghouse, for activated carbon powder, may be used. Baghouse with high collection efficiency may be installed in the power plant facilities. However, these measures are costly and may be impractical, especially for small power plants.

Since water-soluble (oxidized) mercury is the main mercury species in bituminous coal flue gas with high concentrations of SO₂ and HCl, bituminous coal-fired plants may be able to remove 90% mercury using a wet scrubber combined with NOx and/or SO₂ control technologies. Mercury emission control can also achieve as a co-benefit of particulate emission control. Chelating agent may be added to a wet scrubber to sequestrate the mercury from emitting again. However, a chelating agent adds to the cost due to the problems of corrosion of the metal scrubber equipment and treatment of chelating solution. However, elemental mercury is the dominant mercury species in the flue gas of sub-bituminous coal or lignite coal and a wet scrubber is not effective for removal of elemental mercury unless additional chemicals are added to the system. The prior art discloses adding various chemicals to the gas stream to aid the removal of mercury. However, it is undesirable to add additional potentially environmentally hazardous material into the flue gas system.

Certain industrial gases, such as the syngas produced in coal gasification, may contain toxic elements such as arsenic, cadmium and selenium, in addition to mercury. It is highly desired that all these toxic elements be substantially abated before the syngas is supplied for industrial and/or residential use.

There is a genuine need of a sorbent material capable of removing mercury and/or other toxic elements from fluid streams such as flue gas and syngas with a higher capacity than activated carbon powder alone. It is desired that such sorbent material can be produced at a reasonable cost and conveniently used, such as in a fixed bed.

The present invention satisfies this need.

### SUMMARY OF THE INVENTION

Thus, according to a first aspect of the present invention, provided is a sorbent body comprising:

an activated carbon matrix defining a plurality of pores;

sulfur; and

an additive adapted for promoting the removal of at least one of As, Cd, Hg and Se from a fluid stream,

wherein:

the additive is distributed essentially on the wall surfaces of the pores; and

the sorbent body comprises less than 10% (in certain embodiments less than 8%, in certain other embodiments less than 5%, in certain other embodiments less than 3%, in certain other embodiments less than 1%) by weight of inorganic materials other than carbon, sulfur-containing inorganic material and the additive.

According to certain embodiments of the present invention, the sorbent body is in the form of a monolith. According to certain embodiments, the sorbent body is in the form of a monolithic honeycomb with a plurality of channels through which gas and liquid may pass.

According to certain embodiments of the sorbent body of the present invention, sulfur is distributed throughout the activated carbon matrix. According to certain embodiments, sulfur is distributed substantially homogeneously throughout the activated carbon matrix.

According to certain embodiments of the sorbent body of the present invention, at least some sulfur is covalently bonded to the activated carbon matrix.

According to certain embodiments of the sorbent body of the present invention, the activated carbon matrix defines a plurality of nanoscale pores.

According to certain embodiments of the sorbent body of the present invention, the additive is present on the wall surface of at least part of the nanoscale pores.

According to certain embodiments of the sorbent body of the present invention, sulfur is present on the wall surface of at least part of the nanoscale pores.

According to certain embodiments of the sorbent body of the present invention, the activated carbon matrix further defines a plurality of microscale pores.

According to certain embodiments of the sorbent body of the present invention, a majority of the additive is present on the wall surface of the microscale pores. According to certain other embodiments, at least 60% (in certain embodiments at least 65%, in certain embodiments at least 70%, in certain embodiments at least 75%, in certain embodiments at least 80%, in certain embodiments at least 85%, in certain embodiments at least 90%) by mole of the additive is present on the wall surface of the microsale pores.

According to certain embodiments of the sorbent body of the present invention, at least part of the additive forms a layer of coating on the wall surface of microscale pores.

According to certain embodiments of the sorbent body of the present invention, at least some sulfur is present in a state capable of chemically (such as covalently) bonding with Hg.

According to certain embodiments of the sorbent body of the present invention, at least 10% (in certain embodiments at least 20%, in certain embodiments at least 30%, in certain embodiments at least 40%, in certain embodiments at least 50%, in certain embodiments at least 60%, in certain embodiments at least 70%) by mole of the sulfur on the surface of the walls of the pores is essentially at zero valency when measured by XPS.

According to certain embodiments of the present invention, the sorbent body further comprises an inorganic filler.

According to certain embodiments of the sorbent body of the present invention, the inorganic filler is selected from: silica; mullite; cordierite; alumina; other oxide glass; other ceramic materials; other refractory materials; and mixtures and combinations of at least two thereof.

According to certain embodiments of the sorbent body of the present invention, the additive is selected from: (i) halides, oxides and hydroxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; and (iv) combinations and mixtures of two or more of (i), (ii) and (iii).

According to certain embodiments of the sorbent body of the present invention, the additive is selected from: (i) oxides, sulfides and salts of manganese; (ii) oxides, sulfides and salts of iron; (iii) combinations of (i) and KI; (iv) combinations of (ii) and KI; and (v) mixtures and combinations of any two or more of (i), (ii), (iii) and (iv). According to certain embodiments of the present invention, the sorbent body comprises an alkaline earth metal hydroxide as an additive for promoting the removal of toxic elements, such as Ca(OH)₂.

According to certain embodiments of the present invention, the sorbent body comprises at least 90% by weight of activated carbon, sulfur and the additive in total (in certain embodiments at least 95%, in certain other embodiments at least 98%).

According to certain embodiments of the present invention, the sorbent body comprises from 50% to 97% by weight of carbon (in certain embodiments from 60% to 97%, in certain other embodiments from 85% to 97%, in certain other embodiments from 90% to 97%).

According to certain embodiments of the present invention, the sorbent body comprises from 1% to 20% by weight of sulfur (in certain embodiments from 1% to 15%, in certain other embodiments from 3% to 8%).

According to certain embodiments of the present invention, the sorbent body comprises from 1% to 25% by weight of the additive (in certain embodiments from 1% to 20%, in certain other embodiments from 1% to 15%, in certain other embodiments from 3% to 10%).

According to certain embodiments of the present invention, the sorbent body has a specific surface area from 50 to 2000 m²·g⁻¹, in certain embodiments from 200 to 2000 m²·g⁻¹, in certain other embodiments from 400 to 1500 m²·g⁻¹.

According to certain embodiments of the present invention, the sorbent body is a monolithic honeycomb having a cell density from 25 to 500 cells·inch⁻² (3.88 to 77.5 cells·cm⁻²), from 50 to 200 cells·inch⁻² (7.75 to 31.0 cells·cm⁻²) in certain other embodiments, and from 50 to 100 cells·inch⁻² (7.75 to 15.5 cells·cm⁻²) in certain other embodiments.

According to certain embodiments of the present invention, the sorbent body is a monolithic honeycomb body having a plurality of channels, where part of the channels are plugged at one end of the sorbent body, and part of the channels are plugged at the other end of the sorbent body. According to certain embodiments, if one channel is plugged at one end, at least a majority (in certain embodiments all) of the channels immediately proximate thereto are plugged at the other end.

According to certain embodiments of the present invention, the sorbent body has an initial Hg removal efficiency of at least 90% with respect to RFG1 (defined infra), in certain embodiments of at least 95%, in certain other embodiments at least 98%, in certain other embodiments at least 99%. According to certain embodiments of the present invention, the sorbent body has an initial Hg removal efficiency of at least 0.95% with respect to RFG2 (defined infra), in certain embodiments of at least 95%, in certain other embodiments at least 98%, in certain other embodiments at least 99%. According to certain embodiments of the present invention, the sorbent body has an initial Hg removal efficiency of at least 0.95% with respect to RFG3 (defined infra), in certain embodiments of at least 95%, in certain other embodiments at least 98%, in certain other embodiments at least 99%.

According to certain embodiments of the present invention, the sorbent body has a Hg removal capacity of 0.05 mg·g⁻¹ with respect to RFG1 (defined infra), in certain embodiments of at least 0.10 mg·g⁻¹, in certain other embodiments at least 0.15 mg·g⁻¹, in certain other embodiments at least 0.20 mg·g⁻¹, in certain other embodiments at least 0.30 mg·g⁻¹. According to certain embodiments of the present invention, the sorbent body has a Hg removal capacity of 0.05 mg·g⁻¹ with respect to RFG2 (defined infra), in certain embodiments of at least 0.10 mg·g⁻¹, in certain other embodiments at least 0.15 mg·g⁻¹, in certain other embodiments at least 0.20 mg·g⁻¹, in certain other embodiments at least 0.30 mg·g⁻¹. According to certain embodiments of the present invention, the sorbent body has a Hg removal capacity of 0.05 mg·g⁻¹ with respect to RFG3 (defined infra), in certain embodiments of at least 0.10 mg·g⁻¹, in certain other embodiments at least 0.15 mg·g⁻¹, in certain other embodiments at least 0.20 mg·g⁻¹, in certain other embodiments at least 0.30 mg·g⁻¹.

A second aspect of the present invention is a process for making a sorbent body comprising an activated carbon matrix defining a plurality of pores, sulfur, and at least one additive adapted for promoting the removal of toxic elements such as As, Cd, Hg and/or Se from a fluid stream, wherein the additive is distributed essentially on the wall surface of the pores of the activated carbon matrix, and the sorbent body comprises less than 10% (in certain embodiments less than 8%, in certain other embodiments less than 5%) by weight of inorganic materials other than carbon, sulfur-containing inorganic material and the additive, comprising the following steps:

(A) providing a batch mixture body formed of a batch mixture material comprising a carbon-source material, a sulfur-source material and an optional filler material;

(B) carbonizing the batch mixture body by subjecting the batch mixture body to an elevated carbonizing temperature in an O₂-depleted atmosphere to form a carbonized batch mixture body;

(C) activating the carbonized batch mixture body at an elevated activating temperature in a CO₂— and/or H₂O-containing atmosphere to form an activated body comprising a carbon matrix defining a plurality of pores; and

(D) loading the additive onto the wall surface of the pores of the carbon matrix of the activated body.

According to certain embodiments of the process of the present invention, in step (A), the carbon-source material comprises: synthetic carbon-containing polymeric material; activated carbon powder; charcoal powder; coal tar pitch; petroleum pitch; wood flour; cellulose and derivatives thereof; wheat flour; nut-shell flour; starch; coke; coal; or mixtures or combinations of any two or more thereof. According to certain embodiments of the process of the present invention, in step (A), the sulfur-source material comprises: sulfur powder; sulfur-containing powdered resin; sulfides; sulfates; and other sulfur-containing compounds; or mixtures or combination of any two or more thereof.

According to certain embodiments of the process of the present invention, step (A) comprises providing a batch mixture body formed of a batch mixture material comprising: a pre-polymerized carbon-containing polymer material comprising sulfur-containing particles distributed therein.

According to certain embodiments of the process of the present invention, in step (A), the filler material comprises: mullite; cordierite; silica; alumina; other oxide glass; other oxide ceramics; or other refractory material.

According to certain embodiments of the process of the present invention, in step (A), the batch mixture material comprises a phenolic resin or a resin based on furfuryl alcohol.

According to certain embodiments of the process of the present invention, in step (A), the batch mixture is curable when being subjected to heat treatment at a curing temperature.

According to certain embodiments of the process of the present invention, step (A) comprises the following step (A1):

(A1) extruding the batch mixture material to form an extruded batch mixture body.

According to certain embodiments of the process of the present invention, step (A) further comprises the following step (A2) after step (A1):

(A2) curing the extruded batch mixture body at a curing temperature to obtain a cured batch mixture body.

According to certain embodiments of the process of the present invention, in step (A), the extruded batch mixture body takes the shape of a monolithic honeycomb having a plurality of channels.

According to certain embodiments of the process of the present invention, after step (C), the sorbent body takes the shape of a monolithic honeycomb having a plurality of channels.

According to certain embodiments of the process of the present invention, the batch mixture material is selected such that at the end of step (C), the sorbent body comprises less than 10% by weight of inorganic materials other than carbon, sulfur and the additive (in certain embodiments less than 8%, in certain other embodiments less than 5%, in certain other embodiments less than 3%, in certain other embodiments less than 1%).

According to certain embodiments of the process of the present invention, after step (C), the sorbent body thus obtained has a surface area from 50 to 2000 m²·g⁻¹, in certain other embodiments from 100 to 1500 m²·g⁻¹, in certain other embodiments from 100 to 1200 m²·g⁻¹, in certain other embodiments from 200 to 1800 m²·g⁻¹, in certain other embodiments from 400 to 1500 m²·g⁻¹.

According to certain embodiments of the process of the present invention, step (D) comprises the following steps:

(D1) impregnating the activated body with a liquid material comprising the additive; and

(D2) drying the impregnated activated body to form the sorbent body comprising an activated carbon matrix.

According to certain embodiments of the process of the present invention, step (D) comprises the following step (DA):

(DA) subjecting the activated body to an atmosphere comprising the additive.

According to certain embodiments of the process of the present invention, in step (D), the additive comprises an alkaline earth metal hydroxide such as Ca(OH)₂.

Another aspect of the present invention is directed to a process for abating As, Cd, Se and/or Hg from a fluid stream, comprising placing a sorbent body described summarily supra in the fluid stream (such as a gas stream). According to certain embodiments of this process, the fluid stream is a gas stream comprising mercury and at least 10%, in certain embodiments at least 30%, in certain embodiments at least 40%, in certain embodiments at least 50%, in certain other embodiments at least 60%, by mole of mercury is in the elemental state.

According to certain embodiments of the process for abating toxic elements, the gas stream comprises mercury and less than 30 ppm by volume of HCl.

According to certain embodiments of the process for abating toxic elements, the gas stream comprises mercury and at least 3 ppm by volume of SO₃.

Certain embodiments of the present invention have the following advantages. First, sorbent materials having high specific surface area and large number of active sites capable of sorbing or promoting sorption of toxic elements can be produced and used effectively for abatement of toxic elements, especially arsenic, cadmium, mercury and/or selenium, particularly mercury. Second, the sorbent material of certain embodiments of the present invention is effective for sorption of not just oxidized mercury, but also elemental mercury. Further, the sorbent bodies according to certain embodiments of the present invention are found to be effective in removing mercury from flue gases with high and low concentrations of HCl alike. Last but not least, the sorbent bodies according to certain embodiments of the present invention are found to be effective in removing mercury from flue gases with high concentration of SO₃.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a diagram showing mercury removal capability of a sorbent body of an embodiment of the present invention, comprising impregnated additive, over a certain period of testing time.

FIG. 2 is a diagram showing mercury removal capability of a comparative sorbent body comprising large amount of inorganic filler and impregnated additive over a certain period of testing time.

FIG. 3 is a SEM photograph of the cross-section of a honeycomb sorbent body of the present invention.

### DETAILED DESCRIPTION OF THE INVENTION

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, in describing and claiming the present invention, the use of the indefinite article “a” or “an” means “at least one,” and should not be limited to “only one” unless explicitly indicated to the contrary. Thus, for example, reference to “a mercury containing compound” includes embodiments having two or more such mercury containing compounds, unless the context clearly indicates otherwise.

As used herein, a “wt %” or “weight percent” or “percent by weight” of a component, unless specifically stated to the contrary, is based on the total weight of the composition or article in which the component is included. As used herein, all percentages are by weight of the total weight of the sorbent body unless indicated otherwise. All ppm of a gas are by volume unless indicated otherwise.

In the present application, each element present in the sorbent body is referred to in the collective, including any such element at any oxidation state, unless indicated otherwise. Thus, the term “sulfur” as used herein includes sulfur element at and all oxidation state, including, inter alia, elemental sulfur (0), sulfate (+6), sulfite (+4), and sulfide (−2).

By “in-situ extruded” is meant that the relevant material, such as sulfur and/or additive, is introduced into the body by incorporating at least part of the source material thereof into the batch mixture material, such that the extruded body comprises the source materials incorporated therein.

Distribution of sulfur, additive or other materials across a cross-section of the sorbet body, or an extrusion batch mixture body, or a batch mixture material, of the present invention can be measured by various techniques, including, but not limited to, microprobe, XPS (X-ray photoelectron spectroscopy), and laser ablation combined with mass spectroscopy.

The methodology of characterizing the distribution of a certain material (e.g., sulfur, an additive, and the like) in a certain planar cross-section of a sorbet body, or other body, is described as follows. This methodology is referred to as “Distribution Characterization Method” in the present application.

Target test areas of the cross-section of at least 500 μm×500 μm size are chosen if the total cross-section is larger than 500 μm×500 μm. The full cross-section, if less than or equal to 500 μm×500 μm, would be a single target test area. The total number of target test areas is p (a positive integer).

Each target test area is divided by a grid into multiple separate 20 μm×20 μm zones. Only zones having an effective area (defined below) not less than 40 μm² are considered and those having an effective area lower than 40 μm² are discarded in the data processing below. Thus the total effective area (ATE) of all the square sample zones of the target test area is:

$$ATE = {\sum }_{i = 1}^{n} ae ( i ) ,$$

where ae(i) is the effective area of zone i, and n is the total number of the square sample zones in the target test area, where ae(i)≧40 μm². Area of individual square zone ae(i) in square micrometers are calculated as follows:

ae(i)=400−av(i)

where av(i) is the total area in square micrometers of any voids, pores or free space larger than 10 μm² within square zone i.

Each square zone i is measured to have an average concentration C(i), expressed in terms of moles of sulfur atoms per unit effective area for sulfur, or moles of other relevant material in the case of an additive. All C(i) (i=1 to n) are then listed in descending order to form a permutation CON(1), CON(2), CON(3), . . . CON(n), where CON(1) is the highest C(i) among all n zones, and CON(n) is the lowest C(i) among all n zones. The arithmetic average concentration of the 5% of all n zones in the target test area having the highest concentrations is CON(max). Thus:

$$CON ( max ) = \frac{{\sum }_{m = 1}^{INT ( 0.05 \times n )} CON ( m )}{INT ( 0.05 \times n )} .$$

The arithmetic average concentration of the 5% of all n zones in the target test area having the lowest concentrations is CON(min). Thus:

$$CON ( min ) = \frac{{\sum }_{m = INT ( 0.95 \times n )}^{n} CON ( m )}{n - INT ( 0.95 \times n )} .$$

The arithmetic average concentration of the target test area is CON(av). Thus:

$$CON ( av ) = \frac{{\sum }_{m = 1}^{n} CON ( m )}{n} .$$

For all p target test areas, all CON(av)(k) (k=1 to p) are then listed in descending order to form a permutation CONAV(1), CONAV(2), CONAV(3), . . . CONAV(p), where CONAV(1) is the highest CON(av)(k) among all p target test areas, and CONAV(p) is the lowest CON(av)(p) among all p target test areas. The arithmetic average concentration of all p target test areas is CONAV(av). Thus:

$$CONAV ( av ) = \frac{{\sum }_{k = 1}^{p} CONAV ( k )}{p} .$$

In certain embodiments of the bodies or materials according to the present invention, where the relevant material is distributed throughout the body, or the activated carbon matrix, or the material, it is desired that: in each target test area, the distribution thereof has the following feature: CON(av)/CON(min)≦30, and CON(max)/CON(av)≦30. In certain other embodiments, it is desired that CON(av)/CON(min)≦20, and CON(max)/CON(av)≦20. In certain other embodiments, it is desired that CON(av)/CON(min)≦15, and CON(max)/CON(av)≦15. In certain other embodiments, it is desired that CON(av)/CON(min)≦10, and CON(max)/CON(av)≦10. In certain other embodiments, it is desired that CON(av)/CON(min)≦5, and CON(max)/CON(av)≦5. In certain other embodiments, it is desired that CON(av)/CON(min)≦3, and CON(max)/CON(av)≦3. In certain other embodiments, it is desired that CON(av)/CON(min)≦2, and CON(max)/CON(av)≦2.

For a certain material or component to be “homogeneously distributed” to have a “homogeneous distribution” in a body or a material according to the present application, the distribution thereof according to the Distribution Characterization Method satisfies the following: in each target test area, for all CON(m) where 0.1n≦m≦0.9n: 0.5≦CON(m)/CON(av)≦2.

In certain embodiments, it is desired that. 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments, for all CON(m) where 0.05n≦m≦0.95n: 0.5≦CON(m)/CON(av)≦2; in certain embodiments, 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments of the bodies (sorbet body, extrusion mixture body, and the like) and material of the present invention, in addition to any one of the features stated above in this paragraph with respect to each individual target test area, the distribution of the relevant material (e.g., sulfur, an additive, and the like) with respect to all p target test areas has the following feature: for all CONAV(k) where 0.1p≦k≦0.9p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05. In certain embodiments, for all CONAV(k) where 0.05p≦k≦0.95p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05.

A first aspect of the present invention is directed to a sorbent body adapted for removing mercury and other toxic elements from a fluid stream such as a flue gas stream resulting from coal combustion or waste incineration or syngas produced during coal gasification process. As described supra, it is generally known that such gas streams contain various amounts of mercury and/or other toxic elements such as As, Cd and Se before any removal procedure is undertaken. Mercury abatement for those gas streams is one of the major concerns. Mercury can be present in elemental state or oxidized state at various proportion in such gas streams depending on the source material (e.g., bituminous coal, sub-bituminous coal, municipal waste, and medical waste) and process conditions.

The sorbent body of the present invention comprises an activated carbon matrix, sulfur and an additive adapted for promoting the removal of arsenic, cadmium, mercury and/or selenium from the fluid stream to be treated. The additive typically comprises a metal element. It is believed that, by a combination of physical and chemical sorption, the sorbent body of the present invention is capable of binding and trapping mercury both at elemental state and oxidized state. The sorbent bodies and material of certain embodiments of the present invention are particularly effective for removing mercury at elemental state in a flue gas stream. This is particularly advantageous compared to certain prior art technology which is usually less effective in removing elemental mercury.

The sorbent body of the present invention may take various shapes. For example, the sorbent body may be a powder, pellets, or an extruded monolith. The sorbent bodies of the present invention may be incorporated in a fixed sorbent bed through which the fluid stream to be treated flows. In certain embodiments, especially when used in treating the coal combustion flue gas in power plants or the syngas produced in coal gasification processes, it is highly desired that any fixed bed through which the gas stream passes has a low pressure-drop. To that end, it is desired that sorbent pellets packed in the fixed bed allow for sufficient gas passageways. In certain embodiments, it is particularly advantageous that the sorbent body of the present invention is in the form of extruded monolithic honeycomb having multiple channels. Cell density of the honeycomb can be adjusted during the extrusion process to achieve various degree of pressure-drop when in use. Cell density of the honeycomb can range from 25 to 500 cells·inch⁻² (3.88 to 77.5 cells·cm⁻²) in certain embodiments, from 50 to 200 cells·inch⁻² (7.75 to 31.0 cells·cm⁻²) in certain other embodiments, and from 50 to 100 cells·inch⁻² (7.75 to 15.5 cells·cm⁻²) in certain other embodiments. To allow for a more intimate contact between the gas stream and the sorbent body material, it is desired in certain embodiments that part of the channels are plugged at one end of the sorbent body, and part of the channels are plugged at the other end of the sorbent body. In certain embodiments, it is desired that at each end of the sorbent body, the plugged and/or unplugged channels form a checkerboard pattern. In certain embodiments, it is desired that where one channel is plugged on one end (referred to as “the reference end”) but not the opposite end of the sorbent body, at least a majority of the channels (preferably all in certain other embodiments) immediately proximate thereto (those sharing at least one wall with the channel of concern) are plugged at the other end of the sorbent body but not on the reference end. Multiple honeycombs can be stacked in various manners to form actual sorbent beds having various sizes, service duration, and the like, to meet the needs of differing use conditions.

Activated carbon, owing to its typically high specific area, has been used for abating mercury from flue gas stream of coal power plants. However, as described supra, activated carbon alone does not have sufficient removal capability. Using a combination of sulfur and activated carbon for mercury abatement was proposed in the prior art. Whereas such combination does provide modest improvement over activated carbon alone in terms of mercury abatement capability, sorbent body having even higher mercury abatement efficiency and capacity, especially when used in a fixed bed, is highly desired.

The “activated carbon matrix,” as used herein, means a network formed by interconnected carbon atoms and/or particles. As is typical for activated carbon materials, the matrix comprises wall structure defining a plurality of interconnected pores. The activated carbon matrix, along with sulfur and the additive, provides the backbone structure of the sorbent body. In addition, the large cumulative areas of the pores in the activated carbon matrix provide a plurality of sites where mercury sorption can occur directly, or where sulfur and the additive can be distributed, which further promote mercury sorption.

In certain embodiments of the present invention, the sorbent body comprises from 50% to 97%, in certain embodiments from 60% to 97%, in certain other embodiments from 85% to 97%, by weight of carbon. Higher concentration of carbon usually leads to higher porosity if the same level of carbonization and activation were used during the process of making the sorbent body of the present invention according to the process of the present invention for making such bodies to be detailed infra.

The pores defined by the activated carbon matrix in the sorbent body of the present invention are divided into two categories: nanoscale pores having a diameter of less than or equal to 10 nm, and microscale pores having a diameter of higher than 10 nm. Pore size and distribution thereof in the sorbent body of the present invention can be measured by using technique available in the art, such as, e.g., nitrogen adsorption. Cells having a diameter larger than 10 nm in a honeycomb sorbent body are regarded as microscale pores in the meaning of the present application. To the extent most cells in extruded honeycomb structures have diameter larger than 10 nm, most of them would be regarded as microscale pores. Both the surfaces of the nanoscale pores and the microscale pores together provide the overall high specific area of the sorbent body of the present invention. In certain embodiments of the sorbent body of the present invention, the wall surfaces of the nanoscale pores constitute at least 50% of the specific area of the sorbent body. In certain other embodiments, the wall surfaces of the nanoscale pores constitute at least 60% of the specific area of the sorbent body. In certain other embodiments, the wall surfaces of the nanoscale pores constitute at least 70% of the specific area of the sorbent body. In certain other embodiments, the wall surfaces of the nanoscale pores contribute to at least 80% of the specific area of the sorbent body. In certain other embodiments, the wall surfaces of the nanoscale pores contribute to at least 90% of the specific area of the sorbent body.

The sorbent bodies of the present invention are characterized by large specific surface area. In certain embodiments of the present invention, the sorbent bodies have specific areas ranging from 50 to 2000 m²·g⁻¹. In certain other embodiments, the sorbent bodies of the present invention have specific areas ranging from 100 to 1800 m²·g⁻¹. In certain other embodiments, the sorbent bodies of the present invention have specific areas ranging from 200 to 1500 m²·g⁻¹. In certain other embodiments, the sorbent bodies of the present invention have specific areas ranging from 300 to 1200 m²·g⁻¹. Higher specific area of the sorbent body can provide more active sites in the material for the sorption of toxic elements. However, if the specific area of the sorbent body is too high, e.g., higher than 2000 m²·g⁻¹, the sorbent body becomes too porous and the mechanical integrity of the sorbent body suffers. This could be undesirable for certain embodiments where the strength of the sorbent body needs to meet certain threshold requirement.

As indicated supra and infra, the sorbent body of the present invention may comprise a certain amount of inorganic filler materials. In order to obtain a high specific surface area of the sorbent body, it is even desired that, if inorganic fillers are included, such inorganic fillers in and of themselves are porous and contribute partly to the high specific area of the sorbent body. Nonetheless, as indicated supra, most of the high specific area of the sorbent body of the present invention are provided by the pores, especially the nanoscale pores of the activate carbon matrix. Inorganic fillers having specific surface area comparable to that of the activated carbon is usually difficult or costly to be included in the sorbent body of the present invention. Therefore, along with the typical mechanical reinforcement such inorganic fillers would bring to the final sorbent body, it also tends to compromise the overall specific area of the sorbent body. This can be highly undesirable. As indicated supra, a high surface area of the sorbet body usually means more active sites (including carbon sites capable of sorption of the toxic elements, sulfur capable of promoting or direct sorption of the toxic elements, and the additive capable of promoting sorption of the toxic elements) for the sorption of the toxic elements. It is further believed that close proximity of the three categories of active sorption sites in the sorbent body is conducive to the overall sorption capability. The incorporation of large amounts of inorganic fillers dilutes the additive and sulfur in the carbon matrix, adding to the overall average distances between and among these three categories of active sites. Hence, the sorbent body of the present invention has a relative low percentage of inorganic materials other than carbon, sulfur-containing inorganic materials and the additive. The sorbent body of the present invention comprises less than 10% (in certain embodiments less than 8%, in certain other embodiments less than 5%, in certain other embodiments less than 3%, in certain other embodiments less than 2%) by weight of inorganic materials other than carbon, sulfur-containing inorganic material and the additive.

The additive typically comprises a metallic element. Any additive capable of promoting the removal of toxic elements or compounds, especially mercury, arsenic, cadmium and selenium, from the fluid stream to be treated upon contacting can be included in the sorbent body of the present invention. The additive can function in one or more of the following ways, inter alia, to promote the removal of such toxic elements: (i) temporary or permanent chemical sorption (e.g., via covalent and/or ionic bonds) of a toxic element; (ii) temporary or permanent physical sorption of a toxic element; (iii) catalyzing the reaction/sorption of a toxic element with other components of the sorbent body; (iv) catalyzing the reaction of a toxic element with the ambient atmosphere to convert it from one form to another; (v) trapping a toxic element already sorbed by other components of the sorbent body; and (vi) facilitating the transfer of a toxic element to the active sorbing sites. Precious metals (Ru, Th, Pd, Ag, Re, Os, Ir, Pt and Au) and transition metals and compounds thereof are known to be effective for catalyzing such processes. Non-limiting examples of additives that can be included in the sorbent body of the present invention include: precious metals listed above and compounds thereof; alkali and alkaline earth halides, oxides and hydroxides; and oxides, sulfides, and salts of vanadium, chromium, manganese, iron, cobalt, nickel, copper, zinc, niobium, molybdenum, silver, tungsten, and lanthanoids. The metallic elements in the additive(s) can be at various valencies. For example, if iron is included in the additive, it may be present at +3, +2 or 0 valencies or as mixtures of differing valencies, and can be present as metallic iron (0), FeO, Fe₂O₃, Fe₃O₈, FeS, FeCl₂, FeCl₃, FeSO₄, and the like. For another example, if manganese is present in the additive, it may be present at +4, +2 or 0 valencies or as mixtures of differing valences, and can be present as metallic manganese (0), MnO, MnO₂, MnS, MnCl₂, MnCl₄, MnSO₄, and the like.

In certain embodiments of the sorbent body of the present invention, the additive(s) included advantageously are: alkali halides; and oxides, sulfides and salts of manganese and iron. In certain embodiments of the sorbent bodies of the present invention, the additive(s) included advantageously are: combination of KI and oxides, sulfides and salts of manganese; combination of KI and oxides, sulfides and salts of iron; or a combination of KI, oxides, sulfides and salts of manganese and iron. These combinations are found to be particularly effective in removing mercury, especially elemental mercury from a gas stream.

According to certain embodiments of the present invention, the sorbent body comprises an alkaline earth metal hydroxide as an additive for promoting the removal of toxic elements, such as Ca(OH)₂. Experiments have shown that Ca(OH)₂ can be particularly effective in promoting the removal of arsenic, cadmium and selenium from a gas stream.

The amount of the additive present in the sorbent bodies of the present invention can vary, depending on the particular additives used, and application for which the sorbent bodies are used, and the desired toxic element removing capacity and efficiency of the sorbent body. In certain embodiments of the sorbent bodies of the present invention, the amount of the additive included ranges from 1% to 20%, in certain other embodiments from 2% to 18%, in certain other embodiments from 5% to 15%, in certain other embodiments from 5% to 10%, by weight of the total sorbent body.

The distribution of the additive on or in the body of the sorbent body of the present invention is mainly limited to the wall surfaces of the activated carbon matrix. Thus the presence of the specific additive can be, e.g.: (i) on the wall surfaces of nanoscale pores; (ii) on the wall surfaces of microscale pores; (iii) where the sorbent body takes the shape of honeycomb with multiple cells, on the walls of the cells; and (iv) where the sorbent body takes the shape of the honeycomb with multiple cells, in a thin top layer of the sorbent material forming the cell walls. In certain embodiments, part of the additive may be chemically bonded with other components of the sorbent body, such as carbon or sulfur. In certain other embodiments, part of the additive may be physically bonded with the activated carbon matrix or other components. Still in certain other embodiments, part of the additive is present in the sorbent body in the form of particles having nanoscale or microscale size. In certain embodiments, multiple additives are present in the sorbent body of the present invention and at least two of the additives are intimately and essentially evenly mixed with each other. In certain other embodiments, multiple additives are present in the sorbent body of the present invention at least two additives form separate layers on the surfaces of certain pores of the sorbent body, wherein the layers can be adjacent to each other, or separated by certain materials, such as another additive and/or sulfur-containing materials.

In certain embodiments of the sorbent body of the present invention, at least a majority, in certain embodiments at least 60%, in certain other embodiments at least 70%, in certain other embodiments at least 80%, in certain other embodiments at least 90%, of the additive is distributed on the wall surfaces of the microscale pores (including, but not limited to, the wall surfaces of the cells of honeycomb sorbent bodies).

In certain embodiments of the sorbent body of the present invention, with regard to any additive distributed in the sorbent body, the distribution thereof in each target test area has the following feature according to the Distribution Characterization Method: CON(max)/CON(min)≧100. In certain other embodiments: CON(max)/CON(min)≧200. In certain other embodiments: CON(max)/CON(min)≧300. In certain other embodiments: CON(max)/CON(min)≧400. In certain other embodiments: CON(max)/CON(min)≧500. In certain other embodiments: CON(max)/CON(min)≧1000. In certain other embodiments: CON(max)/CON(av)≧50. In certain other embodiments: CON(max)/CON(av)≧100. In certain other embodiments: CON(max)/CON(av)≧200. In certain other embodiments: CON(max)/CON(av)≧300. In certain other embodiments: CON(max)/CON(av)≧400. In certain other embodiments: CON(max)/CON(av)≧500. In certain other embodiments: CON(max)/CON(av)≧1000.

In certain embodiments of the sorbent body of the present invention, with regard to any additive distributed in the sorbent body, the distribution thereof in all p target test areas has the following feature: CONAV(1)/CONAV(n)≧2. In certain other embodiments: CONAV(1)/CONAV(n)≧5. In certain other embodiments: CONAV(1)/CONAV(n)≧8. In certain other embodiments: CONAV(1)/CONAV(n)≧10. In certain other embodiments: CONAV(1)/CONAV(n)≧20. In certain other embodiments: CONAV(1)/CONAV(n)≧30. In certain other embodiments: CONAV(1)/CONAV(av)≧1.5. In certain other embodiments: CONAV(1)/CONAV(av)≧2. In certain other embodiments: CONAV(1)/CONAV(av)≧3. In certain other embodiments: CONAV(1)/CONAV(av)≧4. In certain other embodiments: CONAV(1)/CONAV(av)≧5. In certain other embodiments: CONAV(1)/CONAV(av)≧8. In certain other embodiments: CONAV(1)/CONAV(av)≧10.

The sorbent body of the present invention comprises sulfur. Sulfur may be present in the form of, e.g., elemental sulfur (0 valency), sulfides (−2 valency), sulfite (+4 valency), sulfate (+6 valency). It is desired that at least part of the sulfur is present in a valency capable of chemically bonding with the toxic element to be removed from the fluid stream. To that end, it is desired that at least part of the sulfur is present at −2 and/or zero valency. Some sulfur may be chemically or physically bonded to the wall surface of the activated carbon matrix. Part of the sulfur may be chemically or physically bonded to the additive, as indicated supra, e.g., in the form of a sulfide (FeS, MnS, Mo₂S₃, and the like). It is desired that, in certain embodiments at least 10%, in certain embodiments at least 20%, in certain embodiments at least 30%, in certain embodiments at least 40%, in certain embodiments at least 50%, in certain embodiments at least 60%, in certain embodiments at least 70%, by mole of the sulfur in the sorbent body be at zero valency.

Experiments have demonstrated that sulfur-infused activated carbon can be effective for removing arsenic, cadmium as well as selenium, in addition to mercury, from a gas stream. Experiments have demonstrated that sorbent bodies comprising elemental sulfur tend to have higher mercury removal capability than those without elemental sulfur but with essentially the same total sulfur concentration.

The amount of sulfur present in the sorbent bodies of the present invention can vary, depending on the particular additives used, and application for which the sorbent bodies are used, and the desired toxic element removing capacity and efficiency of sorbent body. In certain embodiments of the sorbent bodies of the present invention, the amount of sulfur included ranges from 1% to 20% by weight, in certain embodiments from 1% to 15%, in certain other embodiments from 2% to 10%, in certain other embodiments from 3% to 8%.

In certain embodiments of the sorbent body of the present invention, sulfur is distributed essentially on the wall surfaces of the pores of the activated carbon matrix. In certain embodiments of the present invention, sulfur is distributed throughout the activated carbon matrix. By “distributed throughout the activated carbon matrix,” it means that sulfur is present not just on the external surface of the sorbent body or cell walls, but also deep inside the sorbent body. Thus the presence of sulfur can be, e.g.: (i) on the wall surfaces of nanoscale pores; (ii) on the wall surfaces of microscale pores; (iii) submerged in the wall structure of the activated carbon matrix; and (iv) partly embedded in the wall structure of the activated carbon matrix. In situations (iii) and (iv), sulfur actually forms part of the wall structure of certain pores of the sorbent body. Therefore, in certain embodiments, some sulfur may be chemically bonded with other components of the sorbent body, such as carbon or the additive. In certain other embodiments, some of the sulfur may be physically bonded with the activated carbon matrix or other components. Still in certain other embodiments, some of the sulfur is present in the sorbent body in the form of particles having nanoscale or microscale size.

Distribution of sulfur in the sorbet body or other body or material according to the present invention can be measured and characterized by the Distribution Characterization Method described supra.

In certain embodiments, the distribution of sulfur in any target test area has the following feature: CON(max)/CON(min)≧100. In certain other embodiments: CON(max)/CON(min)≧200. In certain other embodiments: CON(max)/CON(min)≧300. In certain other embodiments: CON(max)/CON(min)≧400. In certain other embodiments: CON(max)/CON(min)≧500. In certain other embodiments: CON(max)/CON(min)≧1000. In certain other embodiments: CON(max)/CON(av)≧50. In certain other embodiments: CON(max)/CON(av)≧100. In certain other embodiments: CON(max)/CON(av)≧200. In certain other embodiments: CON(max)/CON(av)≧300. In certain other embodiments: CON(max)/CON(av)≧400. In certain other embodiments: CON(max)/CON(av)≧500. In certain other embodiments: CON(max)/CON(av)≧1000.

In certain embodiments of the sorbet body of the present invention, with regard to sulfur distributed in the sorbet body, the distribution thereof in all p target test areas has the following feature:

CONAV(1)/CONAV(n)≧2. In certain other embodiments: CONAV(1)/CONAV(n)≧5. In certain other embodiments: CONAV(1)/CONAV(n)≧8. In certain other embodiments: CONAV(1)/CONAV(n)≧1.5. In certain other embodiments: CONAV(1)/CONAV(av)≧2. In certain other embodiments: CONAV(1)/CONAV(av)≧3. In certain other embodiments: CONAV(1)/CONAV(av)≧4. In certain other embodiments: CONAV(1)/CONAV(av)≧5. In certain other embodiments: CONAV(1)/CONAV(av)≧8. In certain other embodiments: CONAV(1)/CONAV(av)≧10.

In certain other embodiments of the sorbet body of the present invention, with regard to sulfur distributed in the sorbet body, in each target test area, the distribution thereof has the following feature: CON(av)/CON(min)≦30. In certain other embodiments: CON(av)/CON(min)≦20. In certain other embodiments: CON(av)/CON(min)≦15. In certain other embodiments: CON(av)/CON(min)≦10. In certain other embodiments: CON(av)/CON(min)≦5. In certain other embodiments: CON(av)/CON(min)≦3. In certain other embodiments: CON(av)/CON(min)≦2. In certain other embodiments: CON(max)/CON(av)≦30. In certain other embodiments: CON(max)/CON(av)≦20. In certain other embodiments: CON(max)/CON(av)≦15. In certain other embodiments: CON(max)/CON(av)≦10. In certain other embodiments: CON(max)/CON(av)≦5. In certain other embodiments: CON(max)/CON(av)≦3. In certain other embodiments: CON(max)/CON(av)≦2.

In certain embodiments of the sorbet body of the present invention, the distribution of sulfur has the following feature: in each target test area, the distribution thereof has the following feature: CON(av)/CON(min)≦30, and CON(max)/CON(av)≦30. In certain other embodiments, it is desired that CON(av)/CON(min)≦20, and CON(max)/CON(av)≦20. In certain other embodiments, it is desired that CON(av)/CON(min)≦15, and CON(max)/CON(av)≦15. In certain other embodiments, it is desired that CON(av)/CON(min)≦10, and CON(max)/CON(av)≦10. In certain other embodiments, it is desired that CON(av)/CON(min)≦5, and CON(max)/CON(av)≦5. In certain other embodiments, it is desired that CON(av)/CON(min)≦3, and CON(max)/CON(av)≦3. In certain other embodiments, it is desired that CON(av)/CON(min)≦2, and CON(max)/CON(av)≦2.

In certain embodiments of the sorbent body of the present invention, with regard to sulfur distributed in the sorbent body, the distribution thereof in all p target test areas has the following feature: CONAV(1)/CONAV(n)≧2. In certain other embodiments: CONAV(1)/CONAV(n)≧5. In certain other embodiments: CONAV(1)/CONAV(n)≧8. In certain other embodiments: CONAV(1)/CONAV(n)≧1.5. In certain other embodiments: CONAV(1)/CONAV(av)≧2. In certain other embodiments: CONAV(1)/CONAV(av)≧3. In certain other embodiments: CONAV(1)/CONAV(av)≧4. In certain other embodiments: CONAV(1)/CONAV(av)≧5. In certain other embodiments: CONAV(1)/CONAV(av)≧8. In certain other embodiments: CONAV(1)/CONAV(av)≧10.

In certain embodiments of the sorbet body of the present invention, sulfur is homogeneously distributed throughout the activated carbon matrix according to the Distribution Characterization Method described supra. Thus: in each target test area, for all CON(m) where 0.1n≦m≦0.9n: 0.5≦CON(m)/CON(av)≦2. In certain embodiments, it is desired that 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments, for all CON(m) where 0.05n≦m≦0.95n: 0.5≦CON(m)/CON(av)≦2; in certain embodiments, 0.6≦CON(m)/CON(av)≦1.7. In certain other embodiments, it is desired that 0.7≦CON(m)/CON(av)≦1.4. In certain other embodiments, it is desired that 0.8≦CON(m)/CON(av)≦1.2. In certain other embodiments, it is desired that 0.9≦CON(m)/CON(av)≦1.1. In certain embodiments of the bodies (sorbet body, extrusion mixture body, and the like) and material of the present invention, in addition to any one of the features stated above in this paragraph with respect to each individual target test area, the distribution of the relevant material (e.g., sulfur, an additive, and the like) with respect to all p target test areas has the following feature: for all CONAV(k) where 0.1p≦k≦0.9p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05. In certain embodiments, for all CONAV(k) where 0.05p≦k≦0.95p: 0.5≦CONAV(k)/CONAV(av)≦2; in certain embodiments, 0.6≦CONAV(k)/CONAV(av)≦1.7. In certain other embodiments, it is desired that 0.7≦CONAV(k)/CONAV(av)≦1.4. In certain other embodiments, it is desired that 0.8≦CONAV(k)/CONAV(av)≦1.2. In certain other embodiments, it is desired that 0.9≦CONAV(k)/CONAV(av)≦1.1. In certain other embodiments, it is desired that 0.95≦CONAV(k)/CONAV(av)≦1.05.

In certain embodiments of the present invention, sulfur is present on a majority of the wall surfaces of the microscale pores. In certain other embodiments of the present invention, sulfur is present on at least 75% of the wall surfaces of the microscale pores; in certain other embodiments, at least 90%; in certain other embodiments at least 95%; in certain other embodiments, at least 98%; in still certain other embodiments, at least 99%.

In certain embodiments of the present invention, sulfur is present on at least 20% of the wall surfaces of the nanoscale pores; in certain other embodiments at least 30%; in certain other embodiments at least 40%; in certain other embodiments at least 50%; in certain other embodiments at least 60%; in certain other embodiments at least 70%; in certain other embodiments at least 80%; in certain other embodiments at least 85%. In certain embodiments of the present invention, a majority of the specific area of the sorbent body is provided by the wall surfaces of the nanoscale pores. In these embodiments, it is desired that a high percentage (such as at least 40%, in certain embodiments at least 50%, in certain other embodiments at least 60%, in certain other embodiments at least 75%) of the wall surface of the nanoscale pores has sulfur distributed thereon.

In certain embodiments of the present invention, in addition to activated carbon, sulfur and the additive, the sorbent body may further comprise an inorganic filler. Such inorganic fillers may be included for the purpose of, inter alia reducing cost, and improving physical (coefficient of thermal expansion; modulus of rupture, e.g.) or chemical properties (water resistance; high temperature resistance; corrosion-resistance, e.g.) of the sorbent body. Such inorganic filler can be an oxide glass, oxide ceramic, or certain refractory materials. Non-limiting examples of inorganic fillers that may be included in the sorbent body of the present invention include: silica; alumina; zircon; zirconia; mullite; cordierite; refractory metals; and the like. In certain embodiments of the sorbent body of the present invention, the inorganic fillers are per se porous. A high porosity of the inorganic fillers can improve the mechanical strength of the sorbent body without unduly sacrificing the specific area. The inorganic filler may be distributed throughout the sorbent body. The inorganic filler may be present in the form of minuscule particles distributed in the sorbent body. Depending on the application of the sorbent body and other factors, in certain embodiments, the sorbent body may comprise, e.g., up to 10% by weight of inorganic filler, in certain other embodiments up to 8%, in certain other embodiments up to 5%, in certain other embodiments up to 3%, in certain other embodiments up to 1%.

It has been demonstrated that the sorbent material in certain embodiments of the present invention is capable of removing arsenic, mercury and selenium from a typical syngas stream produced during a coal gasification process. It has been found that the sorbent body of the present invention is particularly effective in removing mercury from a flue gas stream. It is believed that the sorbent body in certain embodiments of the present invention is effective for removing cadmium from gas streams comprising this toxic element. The removal capabilities of the sorbent materials with respect to a certain toxic element, e.g., mercury, are typically characterized by two parameters: initial removal efficiency and long term removal capacity. With respect to mercury, the following procedure is to be used to characterize the initial mercury removal efficiency and long term mercury removal capacity recited in the claims:

The sorbent body to be tested is loaded into a fixed bed through which a reference flue gas at 160° C. having a specific composition is passed at a space velocity of 7500 hr⁻¹. Concentrations of mercury in the gas stream are measured before and after the sorbent bed. At any given time, the instant mercury removal efficiency (Eff(Hg)) is calculated as follows:

$$Eff ( Hg ) = \frac{{C}_{0} - {C}_{1}}{{C}_{0}} \times 100 \% ,$$

where C₀ is the total mercury concentration in μg·m⁻³ in the flue gas stream immediately before the sorbent bed, and C₁ is the total mercury concentration in μg·m⁻³ immediately after the sorbent bed. Initial mercury removal efficiency is defined as the average mercury removal efficiency during the first 1 (one) hour of testing after the fresh test sorbent material is loaded. Typically, the mercury removal efficiency of a fixed sorbent bed diminishes over time as the sorbent bed is loaded with more and more mercury. Mercury removal capacity is defined as the total amount of mercury trapped by the sorbent bed per unit mass of the sorbent body material until the mercury removal efficiency diminishes to 90% under the above testing conditions. Mercury removal capacity is typically expressed in terms of mg of mercury trapped per gram of the sorbent material (mg·g⁻¹).

An exemplary test reference flue gas (referenced as RFG1 herein) has the following composition by volume: O₂ 5%; CO₂ 14%; SO₂ 1500 ppm; NOx 300 ppm; HCl 100 ppm; Hg 20-25 μg·m⁻³; N₂ balance; wherein NOₓ is a combination of NO₂, N₂O and NO; Hg is a combination of elemental mercury (Hg(0), 50-60% by mole) and oxidized mercury (40-50% by mole). In certain embodiments of the present invention, the sorbent body of the present invention has an initial mercury removal efficiency with respect to RFG1 of at least 91%, in certain embodiments at least 92%, in certain other embodiments at least 95%, in certain other embodiments at least 97%, in certain other embodiments at least 98%, in certain other embodiments at least 99%, in certain other embodiments at least 99.5%.

In certain embodiments of the present invention, the sorbent material advantageously has a high initial mercury removal efficiency of at least 91% for flue gases comprising O₂ 5%; CO₂ 14%; SO₂ 1500 ppm; NOₓ 300 ppm; Hg 20-25 μg·m⁻¹ having high concentrations of HCl (such as 20 ppm, 30 ppm, 50 ppm, 70 ppm, 100 ppm, 150 ppm, 200 ppm) and low concentrations of HCl (such as 10 ppm, 8 ppm, 5 ppm, 3 ppm, 1 ppm, 0.5 ppm) alike. By “high concentrations of HCl,” it means that HCl concentration in the treated gas is at least 20 ppm. By “low concentration of HCl,” it means that HCl concentration in the treated gas is at most 10 ppm. The sorbent body of certain embodiments of the present invention advantageously has a high initial mercury removal efficiency of at least 91% (in certain embodiments at least 95%, in certain other embodiments at least 98%, in certain other embodiments at least 99.0%, in certain other embodiments at least 99.5%) for a flue gas (referred to as RFG2) having the following composition: O₂ 5%; CO₂ 14%; SO₂ 1500 ppm; NOₓ 300 ppm; HCl 5 ppm; Hg 20-25 μg·m⁻³; N₂ balance. High mercury removal efficiency of these embodiments of the sorbet material of the present invention for low HCl flue gas is particularly advantageous compared to the prior art. In the prior art processes involving injection of activated carbon powder, it is typically required that HCl be added to the flue gas in order to obtain a decent initial mercury removal efficiency. The embodiments of the present invention presenting high mercury efficiency at low HCl concentration allows for the efficient and effective removal of mercury from a flue gas stream without the need of injecting HCl into the gas stream.

In certain embodiments of the present invention, the sorbent material advantageously has a high initial mercury removal efficiency of at least 91% for flue gases comprising O₂ 5%; CO₂ 14%; SO₂ 1500 ppm; NOₓ 300 ppm; Hg 20-25 g·m⁻³, having high concentrations of SO₃ (such as 5 ppm, 8 ppm, 10 ppm, 15 ppm, 20 ppm, ppm) and low concentrations of SO₃ (such as 0.01 ppm, 0.1 ppm, 0.5 ppm, 1 ppm, 2 ppm) alike. By “high concentrations of SO₃” it means that SO₃ concentration in the treated gas is at least 3 ppm by volume. By “low concentration of SO₃,” it means that SO₃ concentration in the treated gas is less than 3 ppm. The sorbent body of certain embodiments of the present invention advantageously has a high initial mercury removal efficiency of at least 91% (in certain embodiments at least 95%, in certain other embodiments at least 98%) for a flue gas (referred to as RFG3) having the following composition: O₂ 5%; CO₂ 14%; SO₂ 1500 ppm; NOₓ 300 ppm; SO₃ 5 ppm; Hg 20-25 μg·m⁻³; N₂ balance. High mercury removal efficiency of certain embodiments of the sorbent body of the present invention for high SO₃ flue gas is particularly advantageous compared to the prior art. In the prior art processes involving the injection of activated carbon powder, it is typically required that SO₃ be removed from the flue gas in order to obtain a decent initial mercury removal efficiency and mercury removal capacity. The embodiments of the present invention presenting high mercury efficiency at high SO₃ concentration allows for the efficient and effective removal of mercury from a flue gas stream without the need of prior removal of SO₃ from the gas stream.

Moreover, in certain embodiments of the present invention, the sorbent material advantageously has a high mercury removal capacity with respect to RFG1 of at least 0.10 mg·g⁻¹, in certain embodiments at least 0.15 mg·g⁻¹, in certain embodiments at least 0.20 mg·g⁻¹, in certain embodiments at least 0.25 mg·g⁻¹, in certain embodiments at least 0.30 mg·g⁻¹.

Moreover, in certain embodiments of the present invention, the sorbent material advantageously has a high mercury removal capacity with respect to RFG2 of at least 0.10 mg·g⁻¹, in certain embodiments at least 0.15 mg·g⁻¹, in certain other embodiments at least 0.20 mg·g⁻¹, in certain other embodiments at least 0.25 mg·g⁻¹, in certain other embodiments at least 0.30 mg·g⁻¹. Thus, the sorbent bodies according to these embodiments have a high mercury removal capacity with respect to low HCl flue gas streams. This is particularly advantageous compared to prior art mercury abatement processes.

Moreover, in certain embodiments of the present invention, the sorbent material advantageously has a high mercury removal capacity of at least 0.10 mg·g⁻¹, in certain embodiments at least 0.15 mg·g⁻¹, in certain embodiments at least 0.20 mg·g⁻¹, in certain embodiments at least 0.25 mg·g⁻¹, in certain embodiments at least 0.30 mg·g⁻¹, with respect to RFG3. Thus, the sorbent bodies according to these embodiments have a high mercury removal capacity with respect to high SO₃ flue gas streams. This is particularly advantageous compared to the prior art mercury abatement processes.

Another aspect of the present invention is the use of the sorbent material of the present invention in a process for treating fluid streams, including gas streams and liquid streams comprising toxic elements and/or compounds, such as arsenic, cadmium, mercury and/or selenium, for abating them. Such process typically comprises a step of placing the sorbent body of the present invention in the fluid stream. Such treatment process is particularly advantageous for abating mercury from the fluid stream.

Due to the exceptional removal ability of elemental mercury from the fluid stream of the sorbent body of certain embodiments of the present invention, a particularly advantageous embodiment of the process comprises placing the sorbent body in a gas stream comprising mercury wherein at least 10% by mole of the mercury is in elemental state. In certain embodiments, at least 20% of the mercury contained in the gas stream is in elemental state, in certain other embodiments at least 30%, in certain other embodiments at least 40%, in certain other embodiments at least 50%, in certain other embodiments at least 60%, in certain other embodiments at least 70%.

Due to the exceptional removal ability of mercury from the fluid stream of the sorbent body of certain embodiments of the present invention, even if the gas stream comprises HCl at a very low level, a particularly advantageous embodiment of the process comprises placing the sorbent body in a gas stream comprising mercury and HCl at a HCl concentration of lower than 50 ppm by volume, in certain embodiments lower than 40 ppm, in certain other embodiments lower than 30 ppm, in certain other embodiments lower than 20 ppm, in certain other embodiments lower than 10 ppm.

Due to the exceptional removal ability of mercury from the fluid stream of the sorbent body of certain embodiments of the present invention, even if the gas stream comprises SO₃ at a high level, a particularly advantageous embodiment of the process comprises placing the sorbent body in a gas stream comprising mercury and SO₃ at a SO₃ concentration of at least 3 ppm by volume, in certain embodiments at least 5 ppm, in certain other embodiments at least 8 ppm, in certain other embodiments at least 10 ppm, in certain other embodiments at least 20 ppm.

A third aspect of the present invention is directed to the process for making the sorbent body of the present invention. In general, the process comprises the following steps:

(A) providing a batch mixture body formed of a batch mixture material comprising a carbon-source material, a sulfur-source material and an optional filler material;

(B) carbonizing the batch mixture body by subjecting the batch mixture body to an elevated carbonizing temperature in an O₂-depleted atmosphere to form a carbonized batch mixture body;

(C) activating the carbonized batch mixture body at an elevated activating temperature in a CO₂— and/or H₂O-containing atmosphere to form an activated body comprising a carbon matrix defining a plurality of pores; and

(D) loading the additive onto the wall surface of the pores of the carbon matrix of the activated body.

In certain embodiments, the carbon-source material comprises: synthetic carbon-containing polymeric material; activated carbon powder; charcoal powder; coal tar pitch; petroleum pitch; wood flour; cellulose and derivatives thereof; wheat flour; nut-shell flour; starch; coke; coal; or mixtures or combinations of any two or more of these. All these materials contain certain components comprising carbon atoms in its structure units on a molecular level that can be at least partly retained in the final activated carbon matrix of the sorbent body of the present invention.

In one embodiment, the synthetic polymeric material can be a synthetic resin in the form of a solution or low viscosity liquid at ambient temperatures. Alternatively, the synthetic polymeric material can be a solid at ambient temperature and capable of being liquefied by heating or other means. Examples of useful polymeric carbon-source materials include thermosetting resins and thermoplastic resins (e.g., polyvinylidene chloride, polyvinyl chloride, polyvinyl alcohol, and the like). Still further, in one embodiment, relatively low viscosity carbon precursors (e.g., thermosetting resins) can be preferred, having exemplary viscosity ranges from about 50 to 100 cps. In another embodiment, any high carbon yield resin can be used. To this end, by high carbon yield is meant that greater than about 10% of the starting weight of the resin is converted to carbon on carbonization. In another embodiment, the synthetic polymeric material can comprise a phenolic resin or a furfural alcohol based resin such as furan resins. Phenolic resins can again be preferred due to their low viscosity, high carbon yield, high degree of cross-linking upon curing relative to other precursors, and low cost. Exemplary suitable phenolic resins are resole resin such as plyophen resin. An exemplary suitable furan liquid resin is Furcab-LP from QO Chemicals Inc., IN, U.S.A. An exemplary solid resin well suited for use as a synthetic carbon precursor in the present invention is solid phenolic resin or novolak. Still further, it should be understood that mixtures of novolak and one or more resole resins can also be used as suitable polymeric carbon-source material. The synthetic resin may be pre-cured or uncured when mixed with other material to form the batch mixture material. Where the synthetic resin is pre-cured, the pre-cured material may comprise sulfur, or the optional inorganic filler pre-loaded. As indicated infra, in certain embodiments, it is desired that a curable, uncured resin is included as part of the carbon-source material in the batch mixture material. Curable materials undergo certain reactions, such as chain propagation, crosslinking, and the like, to form a cured material with higher degree of polymerization when being subjected to cure conditions, such as mild heat treatment, irradiation, chemical activation, and the like.

In certain embodiments of the present invention, organic binders typically used in extrusion processes can be part of the carbon-source material as well. Exemplary binders that can be used are plasticizing organic binders such as cellulose ethers. Typical cellulose ethers include methylcellulose, ethylhydroxy ethylcellulose, hydroxybutyl-cellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. Further, methylcellulose and/or methylcellulose derivatives are especially suited as organic binders in the practice of the present invention, with methylcellulose, hydroxypropyl methylcellulose, or combinations of these being preferred.

Carbonizable organic fillers may be used as part of the carbon-source material in certain embodiments of the process of the present invention. Exemplary carbonizable fillers include both natural and synthetic, hydrophobic and hydrophilic, fibrous and non-fibrous fillers. For example some natural fillers are soft woods, e.g., pine, spruce, redwood, etc.; hardwoods, e.g., ash, beech, birch, maple, oak, etc.; sawdust, shell fibers, e.g., ground almond shell, coconut shell, apricot pit shell, peanut shell, pecan shell, walnut shell, etc.; cotton fibers, e.g., cotton flock, cotton fabric, cellulose fibers, cotton seed fiber; chopped vegetable fibers, for example, hemp, coconut fiber, jute, sisal, and other materials such as corn cobs, citrus pulp (dried), soybean meal, peat moss, wheat flour, wool fibers, corn, potato, rice, tapiocas, etc. Some synthetic materials are regenerated cellulose, rayon fabric, cellophane, etc. One especially suited carbonizable fiber filler is cellulose fiber as supplied by International Filler Corporation, North Tonawanda, N.Y. This material has the following sieve analysis: 1-2% on 40 mesh (420 micrometers), 90-95% thru 100 mesh (149 micrometers), and 55-60% thru 200 mesh (74 micrometers). Some hydrophobic organic synthetic fillers are polyacrylonitrile fibers, polyester fibers (flock), nylon fibers, polypropylene fibers (flock) or powder, acrylic fibers or powder, aramid fibers, polyvinyl alcohol, etc. Such organic fiberous fillers may function in part as part of the carbon-source material, in part as mechanical property enhancer to the batch mixture body, and in part as fugitive pore formers that would mostly vaporize upon carbonization.

Non-limiting examples of sulfur-source material include: sulfur powder; sulfur-containing powdered resin; sulfides; sulfates; and other sulfur-containing compounds; or mixtures or combination of any two or more of these. Exemplary sulfur-containing compounds can include hydrogen sulfide and/or its salts, carbon disulfide, sulfur dioxide, thiophene, sulfur anhydride, sulfur halides, sulfuric ester, sulfurous acid, sulfacid, sulfatol, sulfamic acid, sulfan, sulfanes, sulfuric acid and its salts, sulfite, sulfoacid, sulfobenzide, and mixtures thereof. When elemental sulfur powder is used, in one embodiment it can be preferred to have an average particle diameter that does not exceed about 100 micrometers. Still further, it is preferred in certain embodiments that the elemental sulfur powder has an average particle diameter that does not exceed about 10 micrometers.

Inorganic fillers are not required to be present in the batch mixture material. However, if present, the filler material can be, e.g.: oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, etc. Some examples of especially suited inorganic fillers are cordierite powder, talcs, clays, and aluminosilicate fibers such as provided by Carborundum Co. Niagara Falls, N.Y. under the name of Fiberfax, and combinations of these. Fiberfax aluminosilicate fibers measure about 2-6 micrometers in diameter and about 20-50 micrometers in length. Additional examples of inorganic fillers are various carbides, such as silicon carbide, titanium carbide, aluminum carbide, zirconium carbide, boron carbide, and aluminum titanium carbide; carbonates or carbonate-bearing minerals such as baking soda, nahcolite, calcite, hanksite and liottite; and nitrides such as silicon nitride.

The batch mixture material may further comprise other components, such as forming aids, fugitive fillers (filler materials that would typically be eliminated during the subsequent carbonization and/or activation steps to leave voids in the shaped body), and the like. To this end, exemplary forming aids can include soaps, fatty acids, such as oleic, linoleic acid, etc., polyoxyethylene stearate, etc. or combinations thereof. In one embodiment, sodium stearate is a preferred forming aid. Optimized amounts of the optional extrusion aid(s) will depend on the composition and binder. Other additives that are useful for improving the extrusion and curing characteristics of the batch are phosphoric acid and oil. Phosphoric acid improves the cure rate and increases adsorption capacity. If included, it is typically about 0.1% to 5 wt % in the batch mixture material. Still further, an oil addition can aid in extrusion and can result in increases in surface area and porosity. To this end, an optional oil can be added in an amount in the range from about 0.1 to 5 wt. % of the batch mixture material. Exemplary oils that can be used include petroleum oils with molecular weights from about 250 to 1000, containing paraffinic and/or aromatic and/or alicyclic compounds. So called paraffinic oils composed primarily of paraffinic and alicyclic structures are preferred. These can contain additives such as rust inhibitors or oxidation inhibitors such as are commonly present in commercially available oils. Some useful oils are 3 in 1 oil from 3M Co., or 3 in 1 household oil from Reckitt and Coleman Inc., Wayne, N.J. Other useful oils can include synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, etc. are also useful. Especially suited are oils having a viscosity of about 10 to 300 cps, and preferably about 10 to 150 cps.

In order to obtain a desired pore structure, an optional pore-forming agent can be incorporated into the batch mixture material. In one embodiment, exemplary pore forming agents can include polypropylene, polyester or acrylic powders or fibers that decompose in inert atmosphere at high temperature (>400° C.) to leave little or no residue. Alternatively, in another embodiment, a suitable pore former can form macropores due to particle expansion. For example, intercalated graphite, which contains an acid such as hydrochloric acid, sulfuric acid or nitric acid, will form macropores when heated, due to the resulting expansion of the acid. Still further, macropores can also be formed by dissolving certain fugitive materials. For example, baking soda, calcium carbonate or limestone particles having a particle size corresponding to desired pore size can be extruded with carbonaceous materials to form monolithic sorbents. Baking soda, calcium carbonate or limestone forms water soluble oxides during the carbonization and activation processes, which can subsequently be leached to form macropores by soaking the monolithic sorbent in water.

In order to obtain a distribution of sulfur throughout the final sorbent body, it is highly desired that the carbon-source materials and the sulfur-source materials are intimately mixed to form the batch mixture material. To that end, it is desired in certain embodiments that the various source materials are provided in the form of fine powders, or solutions if possible, and then mixed intimately by using an effective mixing equipment. When powders are used, they are provided in certain embodiments with average size not larger than 100 μm, in certain other embodiments not larger than 10 μm, in certain other embodiments not larger than 1 μm.

Various equipment and process may be used to form the batch mixture material into the desired shape of the batch mixture body. For example, extrusion, casting, pressing, and the like, may be used for shaping the batch mixture body. Of these, extrusion is especially preferred in certain embodiments. Extrusion can be done by using standard extruders (single-screw, twin-screw, and the like) and custom extrusion dies, to make sorbent bodies with various shapes and geometries, such as honeycombs, pellets, rods, and the like. Extrusion is particularly effective for making monolithic honeycomb bodies having a plurality of empty channels that can serve as fluid passageways. Extrusion is advantageous in that it can achieve a highly intimate mixing of all the source materials as well during the extrusion process.

In certain embodiments of the present invention, it is desired that the batch mixture material comprises an uncured curable material. In those embodiments, upon forming of the batch mixture body, the sorbent body is typically subjected to a curing condition, e.g., heat treatment, such that the curable component cures, and a cured batch mixture body forms as a result. The cured batch mixture body tends to have better mechanical properties than its non-cured predecessor, and thus handles better in down-stream processing steps. Moreover, without the intention or necessity to be bound by any particular theory, it is believed that the curing step can result in a polymer network having a carbon backbone, which can be conducive to the formation of carbon network during the subsequent carbonization and activation steps. In certain embodiments the curing is generally performed in air at atmospheric pressures and typically by heating the formed batch mixture body at a temperature of about 100° C. to about 200° C. for about 0.5 to about 5.0 hours. Alternatively, when using certain precursors, (e.g., furfuryl alcohol) curing can also be accomplished by adding a curing additive such as an acid additive at room temperature. The curing can, in one embodiment, serve to retain the uniformity of the toxic metal adsorbing additive distribution in the carbon.

After formation of the batch mixture body, drying thereof, or optional curing thereof, the shaped body is subjected to a carbonization step, wherein the batch mixture body (cured or uncured) is heated at an elevated carbonizing temperature in an O₂-depleted atmosphere. The carbonization temperature can range from 600 to 1200° C., in certain embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the batch mixture body decompose to leave a carbonaceous residue. As can be expected, complex chemical reactions take place in this high-temperature step. Such reactions can include, inter alia:

(i) decomposition of the carbon-source materials to leave a carbonaceous body;

(ii) decomposition of the sulfur-source materials;

(iii) reactions between the sulfur-source materials and the carbon-source materials;

(iv) reactions between the sulfur-source materials and carbon; and

(v) reactions between the additive-source materials and carbon.

The net effect can include, inter alia: (1) re-distribution of sulfur; (2) formation of elemental sulfur from the sulfur-source material (such as sulfates, sulfites, and the like); (3) formation of sulfur-containing compounds from the sulfur-source material (such as elemental sulfur); and (4) formation of a carbon network. Part of the sulfur (especially those in elemental state) may be swept away by the carbonization atmosphere during carbonization.

The result of the carbonization step is a carbonaceous body with sulfur distributed therein. However, this carbonized batch mixture body typically does not have the desired specific surface area for effective sorption of toxic elements from fluid streams. To obtain the final sorbent body with a high specific surface area, the carbonized batch mixture body is further activated at an elevated activating temperature in a CO₂ and/or H₂O-containing atmosphere. The activating temperature can range from 600° C. to 1000° C., in certain embodiments from 600° C. to 900° C. During this step, part of the carbonaceous structure of the carbonized batch mixture body is mildly oxidized:

CO₂(g)+C(s)→2CO(g),

H₂O(g)+C(s)→H₂(g)+CO(g),

resulting in the etching of the structure of the carbonaceous body and formation of an activated carbon matrix defining a plurality of pores on nanoscale and microscale. The activating conditions (time, temperature and atmosphere) can be adjusted to produce the final product with the desired specific area and composition. Similar to the carbonizing step, due to the high temperature of this activating step, complex chemical reactions and physical changes occur. It is highly desired that at the end of the activation step, sulfur is distributed throughout the activated carbon matrix. It is highly desired that at the end of the activation step, sulfur is distributed substantially homogeneously throughout the activated carbon matrix. It is highly desired that at the end of the activation step, sulfur is present on at least 30%, in certain embodiments at least 40%, in certain other embodiments at least 50%, in certain other embodiments at least 60%, in certain other embodiments at least 80%, of the wall surface area of the pores.

In certain embodiments of the process of the present invention, all sulfur-source materials are included into the batch mixture body by in-situ forming, such as in-situ extrusion, casting, and the like. This process has the advantages of, inter alia: (a) avoiding a subsequent step (such as impregnation) of loading sulfur onto the activated carbon body, thus potentially reducing process steps, increasing overall process yield, and reducing process costs; (b) obtaining a more homogeneous distribution of sulfur in the sorbent body than what is typically obtainable by impregnation; and (c) obtaining a durable and robust fixation of sulfur in the sorbent body, which can withstand the flow of the fluid stream to be treated for a long service period. Sulfur impregnation can result in preferential distribution of impregnated species on cell walls and wall surface of large pores (such as those on the micrometer scale). Loading of impregnated sulfur-containing species onto a high percentage of the wall surfaces of the nanoscale pores can be time-consuming and difficult. Most of the surface area of activated carbon having high specific area of from 400 to 2000 m²·g⁻¹ are contributed by the nanoscale pores. Thus, it is believed that it is difficult for a typical impregnation step to result in loading of the sulfur-containing species onto a majority of the specific area of such activated carbon material. Moreover, it is believed that a typical impregnation step can result in a thick, relatively dense layer of the sulfur-containing material on the cell walls and/or wall surface of large pores, which blocks the fluid passageways into or out of the smaller pores, effectively reducing the sorptive function of the activated carbon. Still further, it is believed that the fixation of the impregnated sulfur-containing species in a typical impregnation step in the sorbent body is mainly by relatively weak physical force, which may be insufficient for prolonged use in fluid streams.

Nonetheless, as indicated supra, in certain embodiments, it is not necessary that all the sulfur is required to be distributed throughout the activated carbon matrix, let alone substantially homogeneously. In these embodiments, not all of the sulfur-source materials are formed in situ into the batch mixture body. It is contemplated that, after the activation step, a step of impregnation of certain sulfur-containing material may be carried out. Alternatively, after the activated step, a step of treating the activated body by a sulfur-containing atmosphere may be carried out.

Upon activation, the additive is loaded into the sorbent body of the present invention. Non-limiting examples of additive-source material include: alkali and alkaline earth halides, oxides and hydroxides; precious metal powder and compounds of precious metals in liquid dispersion or in solid state; oxides, sulfides, and salts of vanadium, chromium, manganese, iron, cobalt, nickel, copper, zinc, niobium, molybdenum, silver, tungsten, and lanthanoids. The metallic elements in the additive-source materials can be at various valencies. For example, if iron is included in the additive-source material, it may be present at +3, +2 or 0 valencies or as mixtures of differing valencies, and can be present as metallic iron (0), FeO, Fe₂O₃, Fe₃O₈, FeS, FeCl₂, FeCl₃, FeSO₄, and the like. For another example, if manganese is present in the additive, it may be present at +4, +2 or 0 valencies or mixtures of differing valences, and can be present as metallic manganese (0), MnO, MnO₂, MnS, MnCl₂, MnCl₄, MnSO₄, and the like. It has been found that a combination of iron compounds (oxides, sulfides, salts, and the like) with alkali metal halides (e.g., KI, and the like), or a combination of manganese compounds (oxides, sulfides, salts, and the like) with alkali metal halides (e.g., KI, and the like), or a combination of iron compounds, manganese compounds and alkali metal halides are particularly advantageous for a high initial mercury removal efficiency. Specific advantageous examples of additive-source materials include: combination of FeSO₄ and KI; combination of MnSO₄ and KI.

Various loading processes can be used. Impregnation by solution, slurry, emulsion, and the like, may be used. Where multiple additive-source materials are used, they may be impregnated at the same time, successively in various orders, or alternatively in multiple impregnation cycles, to achieve the desired distribution of the additive in the final sorbent body. For volatile additive, such as those with a relatively low boiling point or easy to sublime (e.g., KI), loading by an additive-containing atmosphere may be effectively used. Generally, loading processes that can achieve a highly homogeneous distribution of the additive in the sorbent body within a short period of time is preferred. Where wet loading such as wet impregnation is used, the loading process typically includes a sub-step of drying the body to leave the additive on the surface of the microscale pores and wall of cells, if any. Moreover, a thermal treatment step may be carried out after the initial loading step, where the additive-source material deposited on the surfaces are allowed to further diffuse into nanoscale pores, or to undergo chemical reactions to form the desired additive on the pore and/or cell wall surfaces.

Once the activated sorbent body of the present invention is formed, it may be subjected to post-finishing steps, such as pellitizing, grinding, assembling by stacking, and the like. Sorbent bodies of various shapes and compositions of the present invention may then be loaded into a fixed bed which will be placed into the fluid stream to be treated.

The present invention is further illustrated by the following non-limiting examples.

### EXAMPLES

### Example 1

Phenolic resole resin from Georgia Pacific Co, with a viscosity of 100-200 cp was mixed with 10 wt % sulfur powder and 3.5 wt % phosphoric acid. The mixture was dried and cured at 150° C. into a solid mass. This mass was then ground to a fine solid powder with mean particle size of 15 microns. An extrusion batch containing liquid phenolic resin 44.7 wt %, the cured sulfur-phenolic resin powder mixture 18 wt %, sulfur 9.8 wt %, BH40 cellulose fiber 19.5 wt %, methocel F240 binder 4.5 wt %, phosphoric acid 1.5 wt % and 3-in-1 oil 1 wt % were mixed in a muller and then extruded through an extrusion die. Excellent quality honeycomb extrusions were obtained from this batch. The honeycombs were cured at 150° C., carbonized at 900° C. in nitrogen for 6 hours and then activated in carbon dioxide at 900° C. to obtain activated carbon honeycombs for mercury removal.

### Example 2

The sulfur containing resin powder mentioned in example 1 at 68 wt %, BH40 cellulose fiber at 20 wt %, F240 methocel at 8 wt %, LIGA at 1 wt %, 3-in-1 oil at 3 wt % and water superaddition at 50 wt % were mixed in a muller and extruded into honeycomb. Again excellent quality honeycomb extrusions were obtained in this case also. These honeycombs were cured at 150° C. and carbonized at 900° C. in nitrogen and activated in carbon dioxide.

### Example 3

A phenolic epoxy novolac from Durex Corporation (Durez 29217) with mean particle size of 22 microns, at 62 wt %, sulfur at 9 wt %, BH40 cellulose fiber at 18 wt %, F240 methocel at 8 wt %, LIGA at 1 wt %, 3-in-1 oil at 2 wt % and water superaddition at 45 wt % were mixed in a muller and extruded into honeycomb. Excellent quality honeycomb extrusions were obtained in this case also. These honeycombs were cured at carbonized and activated to obtain sulfur-containing carbon honeycombs.

### Example 4

A phenolic epoxy novolac from Georgia Pacific (GP 5520) at 63 wt %, sulfur 12 wt %, BH40 cellulose fiber at 13 wt %, F240 methocel at 10 wt %, LIGA at 1 wt %, 3-in-1 oil at 1 wt % and water superaddition at 50 wt % were mixed in a muller and extruded into honeycomb. This composition also resulted in good quality honeycombs. These samples have also been heat treated as before to obtain sulfur containing honeycombs.

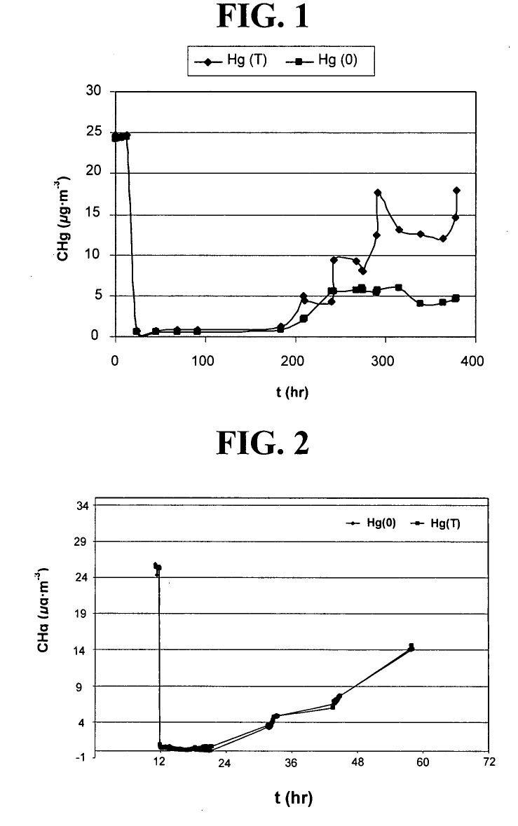

A sample sorbent material of the present invention as well as a comparative, non-inventive sorbent material were tested for mercury removal capability. The results are presented in FIGS. 1 and 2. In these figures, Hg(0) stands for elemental mercury, and Hg(T) stands for total mercury. CHg stands for concentration of mercury (element and/or total). In these figures, on the vertical axis is concentration of mercury in the outlet gas, and on the horizontal axis is test time. The mercury concentration started high (in the first 10-12 hours or so as shown in the figures) in the test because at the beginning of the test, the tested sorbent bodies were bypassed. Once the tested sorbent bodies were placed in the gas stream, the mercury concentration in the outlet gas dropped sharply.

FIG. 1 is a diagram showing mercury removal capability of a sorbent body of an embodiment of the present invention comprising impregnated additive over a certain period of testing time. This sorbent body is essentially free of inorganic fillers, i.e., inorganic materials other than carbon, sulfur and sulfur compounds and the additive. The additives in this sorbent were FeSO₄ and KI. This figure shows a steady, high mercury removal efficiency for a prolonged test period up to 180 hours.

FIG. 2 is a diagram showing mercury removal capability of a comparative sorbent body comprising an impregnated additive and a large amount (approximately 45% by weight) of inorganic filler (cordierite) over a certain period of testing time. The additives included in this sorbent body were FeSO₄ and KI. This figure shows abrupt drop in mercury removal efficiency after about 24 hours of test.

FIGS. 1 and 2 show that a lower amount of inorganic filler in the sorbent body of the present invention leads to a higher mercury removal efficiency.

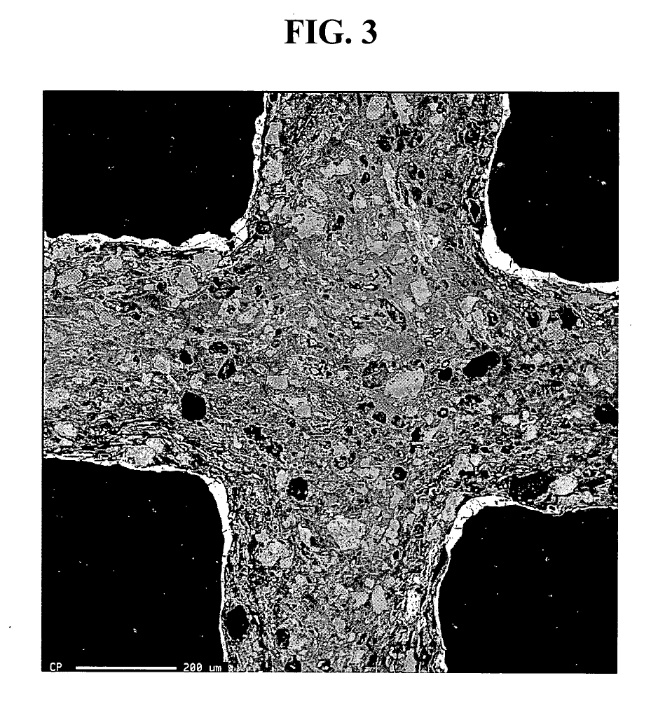

FIG. 3 shows the SEM photograph of part of the cross-section of a honeycomb sorbent body according to the present invention. The photo clearly indicates a preferential distribution of the additive (white parts) on the surfaces of the cell walls, and in a shallow layer below the surfaces of the cell walls.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

What is claimed is:

1. A sorbent body comprising:
an activated carbon matrix defining a plurality of pores;
sulfur; and
an additive adapted for promoting the removal of at least one of As, Cd, Hg and Se from a fluid stream,
wherein:
the additive is distributed essentially on the wall surfaces of the pores; and
the sorbent body comprises less than 10% by weight of inorganic materials other than carbon, sulfur-containing inorganic material and the additive.

2. A sorbent body according to claim 1, which is a monolith.

3. A sorbent body according to claim 1, wherein sulfur is distributed throughout the activated carbon matrix.

4. A sorbent body according to claim 1, wherein sulfur is essentially homogenously distributed in the activated carbon matrix.

5. A sorbent body according to claim 1, wherein a majority of the additive is distributed on the walls of the surfaces of the microscale pores defined by the carbon matrix.

6. A sorbent body according to claim 1, wherein at least part of sulfur is present in a state capable of chemically bonding with Hg.

7. A sorbent body according to claim 6, wherein at least 10% of the sulfur on the surface of the walls of the pores is essentially at zero valency.

8. A sorbent body according to claim 1, wherein the additive is selected from: (i) halides, oxides and hydroxides of alkali and alkaline earth metals; (ii) precious metals and compounds thereof; (iii) oxides, sulfides, and salts of vanadium, chromium, manganese, iron, cobalt, nickel, copper, zinc, niobium, molybdenum, silver, tungsten and lanthanoids; and (iv) combinations and mixtures of two or more of (i), (ii) and (iii).

9. A sorbent body according to claim 1, wherein the additive is selected from: (i) oxides, sulfides and salts of manganese; (ii) oxides, sulfides and salts of iron; (iii) combinations of (i) and KI; (iv) combinations of (ii) and KI; and (v) mixtures and combinations of any two or more of (i), (ii), (iii) and (iv).

10. A sorbent body according to claim 1, wherein the additive comprises an alkaline earth hydroxide such as Ca(OH)₂.

11. A sorbent body according to claim 1, comprising from 50% to 97% by weight of carbon.

12. A sorbent body according to claim 1, comprising from 1% to 20% by weight of sulfur.

13. A sorbent body according to claim 1, comprising from 1% to 25% by weight of the additive.

14. A sorbent body according to claim 1, having an initial Hg removal efficiency of at least 91% with respect to RFG1.

15. A sorbent body according to claim 1, having an initial Hg removal efficiency of at least 91% with respect to RFG2.

16. A sorbent body according to claim 1, having an initial Hg removal efficiency of at least 91% with respect to RFG3.

17. A sorbent body according to claim 1, having a Hg removal capacity of at least 0.10 mg·g⁻¹ with respect to RFG1.

18. A sorbent body according to claim 1, having a Hg removal capacity of at least 0.10 mg·g⁻¹ with respect to RFG2.

19. A sorbent body according to claim 1, having a Hg removal capacity of at least 0.10 mg·g⁻¹ with respect to RFG3.

20. A process for making a sorbent body comprising an activated carbon matrix defining a plurality of pores, sulfur, and at least one additive adapted for promoting the removal of As, Cd, Hg and/or Se from a fluid stream, wherein the additive is distributed essentially on the wall surface of the pores of the activated carbon matrix, and the sorbent body comprises less than 10% by weight of inorganic materials other than carbon, sulfur-containing inorganic material and the additive,
comprising the following steps:
(A) providing a batch mixture body formed of a batch mixture material comprising a carbon-source material, a sulfur-source material and an optional filler material;
(B) carbonizing the batch mixture body by subjecting the batch mixture body to an elevated carbonizing temperature in an O₂-depleted atmosphere to form a carbonized batch mixture body;
(C) activating the carbonized batch mixture body at an elevated activating temperature in a CO₂— and/or H₂O-containing atmosphere to form an activated body comprising a carbon matrix defining a plurality of pores; and
(D) loading the additive onto the wall surface of the pores of the carbon matrix of the activated body.

21. A process according to claim 20, wherein in step (A), the carbon-source material comprises: synthetic carbon-containing polymeric material; activated carbon powder; charcoal powder; coal tar pitch; petroleum pitch; wood flour; cellulose and derivatives thereof; wheat flour; nut-shell flour; or mixtures or combination of any two or more of these.

22. A process according to claim 20, wherein in step (A), the sulfur-source material comprises: sulfur powder; sulfur-containing powdered resin; sulfides; sulfates; and other sulfur compounds; or mixtures or combination of any two or more of these.

23. A process according to claim 20, wherein step (A) comprises providing a batch mixture body formed of a batch mixture material comprising:
a pre-polymerized carbon-containing polymer material comprising sulfur-containing particles distributed therein.

24. A process according to claim 20, wherein in step (D), the additive is selected from alkali and alkaline earth halides; and oxides, sulfides, and salts of vanadium, chromium, manganese, iron, cobalt, nickel, copper, zinc, niobium, molybdenum, silver, tungsten and lanthanoids, and mixtures and combinations thereof.

25. A process according to claim 20, wherein in step (D), the additive is selected from KI, and oxides, sulfides, and salts of manganese, iron, and mixtures and combinations thereof.

26. A process according to claim 20, wherein in step (A), the batch mixture material comprises a phenolic resin and/or a furfuryl alcohol-based resin.

27. A process according to claim 20, wherein in step (A), the extruded batch mixture body takes the shape of a monolithic honeycomb having a plurality of channels.

28. A process according to claim 20, wherein step (D) comprises the following steps:
(D1) impregnating the activated body with a liquid material comprising the additive; and
(D2) drying the impregnated activated body to form the sorbent body comprising an activated carbon matrix.

29. A process according to claim 20, wherein step (D) comprises the following step (DA):
(DA) subjecting the activated body to an atmosphere comprising the additive.

30. A process according to claim 20, wherein in step (D), the additive comprises an alkaline earth metal hydroxide such as Ca(OH)₂.

31. A process for abating As, Cd, Se and/or Hg from a fluid stream, comprising placing a sorbent body according to claim 1 in the fluid stream.

32. A process according to claim 31, wherein the fluid stream is a gas stream comprising mercury and at least 10% by mole of the mercury in the gas stream is in elemental state.

33. A process according to claim 31, wherein the fluid stream is a gas stream comprising mercury and at least 50% by mole of the mercury in the gas stream is in elemental state.

34. A process according to claim 31, wherein the gas stream comprises mercury and less than 50 ppm by volume of HCl.

35. A process according to claim 31, wherein the gas stream comprises mercury and at least 3 ppm by volume of SO₃.

36. A process according to claim 34, wherein the gas stream comprises mercury and at least 3 ppm by volume of SO₃.
